(19) United States
(12) Patent Application Publication
(10) Pub. No.: US 2014/0101199 A1
(43) Pub. Date: Apr. 10, 2014

(54) REST AND ODATA OBJECT NAVIGATION

(71) Applicants: Yiftach Nun, Kubutz Dafna (IL); Inbal Zilberman Kubovsky, Ramat Gan (IL)

(72) Inventors: Yiftach Nun, Kubutz Dafna (IL); Inbal Zilberman Kubovsky, Ramat Gan (IL)

(21) Appl. No.: 13/648,664

(22) Filed: Oct. 10, 2012

(51) Int. Cl. G06F 17/30

(52) U.S. Cl. CPC G06F 17/30864
USPC 707/770

(57) ABSTRACT

According to some embodiments, a method and apparatus are provided to receive a request for a REST or OData object at an input field and suggest a file associated with the REST or OData object.

### BACKGROUND

The Open Data Protocol (“OData”) is an open web protocol for querying and updating data. OData allows a user to query a data source using an HTTP protocol and receive a result in a useable format. OData can be used to expose and access data from several types of data source like databases, file systems and websites.

Representational State Transfer, or REST, is a standard for designing networked software systems based around clients and servers. In a RESTful system, or application, (e.g. an application associated with the REST standard) RESTful applications may use HTTP requests and responses to invoke CRUD (Create/Read/Update/Delete) operations on data objects associated with the application. Data objects are based on an application's data model and are reachable through specific uniform resource identifiers (“URIs”). As well known in the art, a URI is a string of characters used to identify a name or a resource. A URI enables interaction with representations of the resource over a network via the use of specific protocols. When editing an application associated with OData or REST, it is often difficult to know a URI path associated with files or objects.

### BRIEF DESCRIPTION OF THE DRAWINGS

FIG. 1 illustrates a method according to some embodiments.

FIG. 2 illustrates an application interface according to some embodiments.

FIG. 3 illustrates an apparatus according to some embodiments.

FIG. 4 illustrates a portion of a database that might be stored in accordance with some embodiments.

FIG. 5 illustrates an embodiment of an expression.

### DETAILED DESCRIPTION

In conventional systems there is typically no ability or support for auto-completion of a URI associated with resources of a REST application through any browser or via any other tool. Because of this, a user (e.g., developer) may have to be familiar with the data to know exactly how a URI to a certain object should be built, others may need to read every object in the object path to know how to build the URI, and in some cases the developer may not necessarily know how to create the URI at all. Unlike applications that suggest, such as Google, the present embodiments may not filter search results but, instead, they may explore restful application via navigation associated with URIs. For example, a RESTful application may allow ODATA navigation over its objects.

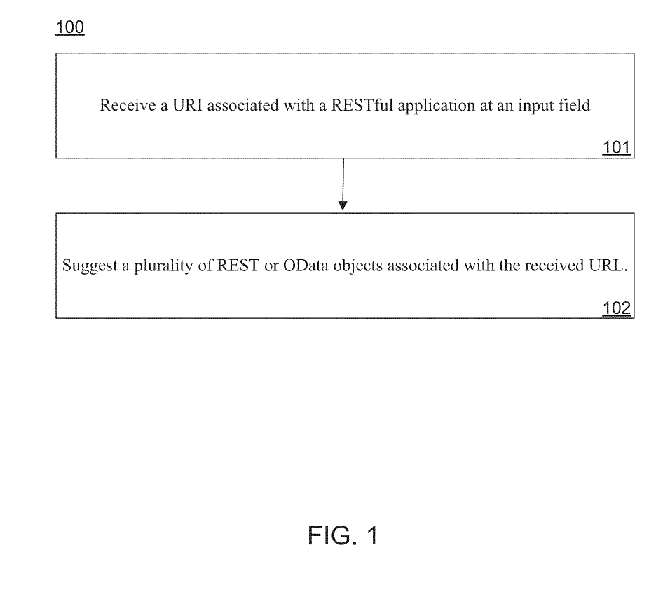

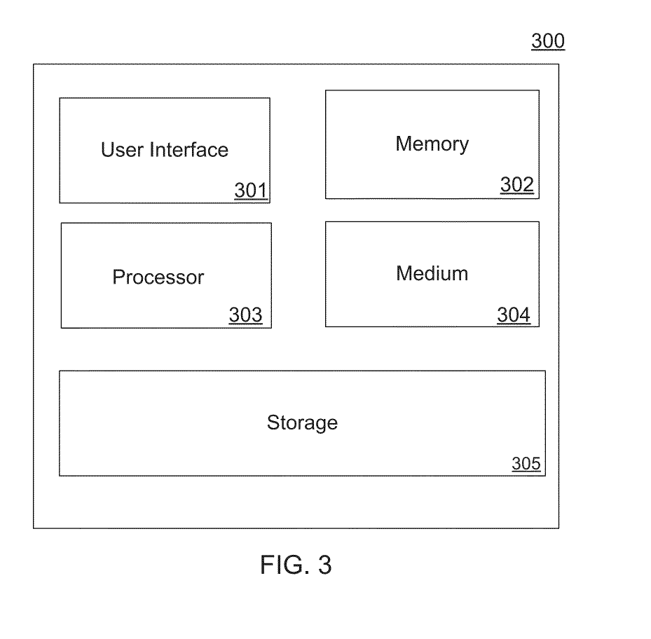

Referring now to FIG. 1, an embodiment of a method 100 is illustrated. The method 100 may be embodied on a non-transitory computer-readable medium. Furthermore, the method 100 may be performed by an apparatus such as, but not limited to, the apparatus of FIG. 3. The method 100 may relate to navigating, via a processor, an object, such as, but not limited to, a file, subroutine, or program, associated with REST or OData based on a received URI. In some embodiments, this method may be implemented as a plugin to a web browser.

When a developer wishes to edit a specific object, the developer must first remember where that object is located. The developer may enter a URI associated with the object into an input field associated with a development application. Thus, at 101, a request for a URI associated with a RESTful application is received at an input field. The input field may be associated with a development application such as, but not limited, to an editor application or a browser. For example, the development application may be used to develop software associated with REST or OData. Once the name of the object (or a partial URI of the object) is received, a call back function may inquire as to the available objects under this URI which will be presented to the user. The information obtained from the inquiry is saved for presenting it later as part of an auto-complete option and is refreshed if needed according to changes in an application. The information may be saved in a database such as that disclosed in FIG. 3.

The present embodiments may facilitate the discovery of objects by providing limited backend information to the service clients while keeping certain backend information and internal data (e.g., intellectual property of the organization, information about systems and/or networks) safe and secured.

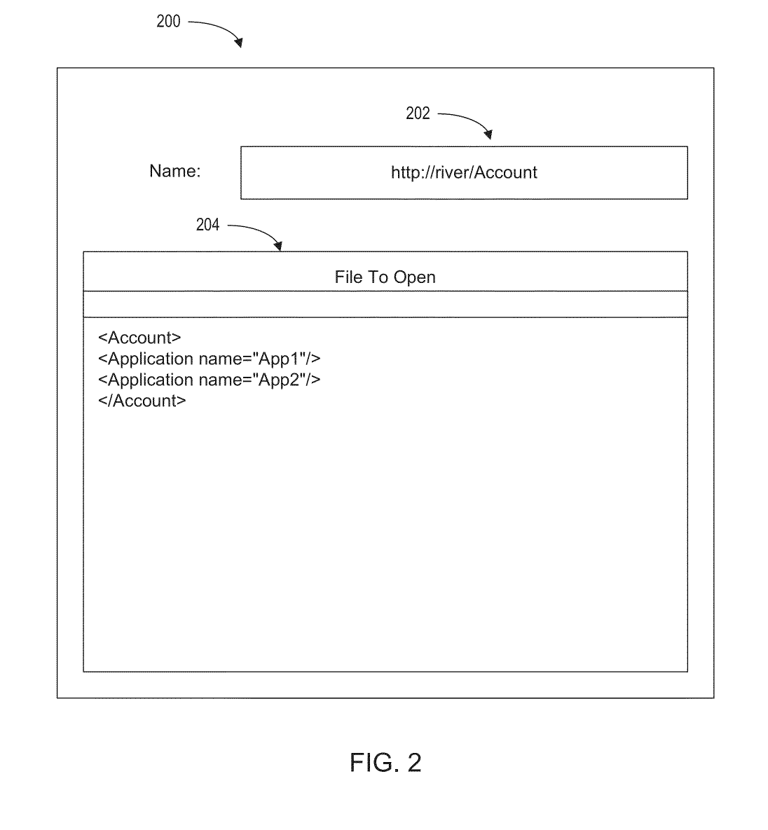

For illustrative purposes, and to aid in understanding features of the specification, an example will now be introduced. This example is not intended to limit the scope of the claims. Now referring to FIG. 2, an embodiment of a development editor 200 is illustrated. The development editor comprises an input field 202 and a search results area 204. As illustrated in the present example, a user types a specific application's URI (e.g., http://river/Account) into the input field 202.

Next, at 102, a plurality of REST or OData objects associated with the received URI is suggested based on the received input. The suggestion may be made using a processor such as the processor described with respect to FIG. 3. The suggestion may be associated with previously opened or accessed objects (e.g., files, applications, programs, subroutines, images, pages, services, etc.). For example, the suggestion may compare a list of previously opened files where the name of the file is associated with the names of the previously opened files. In some embodiments, one of the plurality of REST or OData objects is located in a first directory and a second of the plurality of REST or OData objects is located in a second directory. The second directory may comprise a subdirectory of the first directory.

Continuing with the above example, the URI of “http://river/Account” is entered in the input field 202 of FIG. 2. As illustrated in the results area 204, a plurality of results is displayed where each respective individual result is associated with “http://river/Account”. As further illustrated, the system displays several objects that are found under the URI http://river/Account. In some embodiments, the several objects may be located in different locations on the developer's machine or in different locations in the developer's library. The results of the URI http://river/Account being entered are:

<Account>
<Application name=“App1”/>
<Application name=“App2”/>
</Account>

While illustrated in an XML format, the results may be displayed in any known format.

Accordingly, two objects are returned, the first being application App1 and the second being a second application App2. While applications were returned in the present example, any object may be returned. Furthermore, in some embodiments, the system may display objects that are associated with a partial URI using an autocomplete feature. A user may select an object to be executed or opened (e.g., in an editor) by selecting the object. In some embodiments, selection of the object will navigate the user to a directory that contains the object.

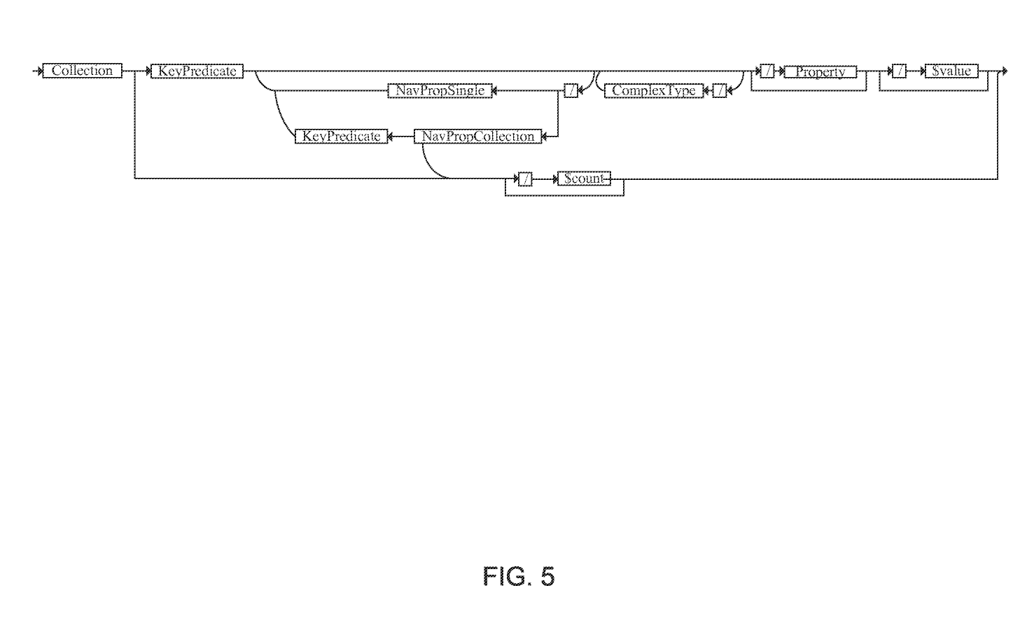

The method 100 may be implemented as a plug-in for a web browser to provide and expose complex types of objects within the application's data model. The plug-in may be associated with running scripts, an extension plug-in, APIs, etc. The plug-in may facilitate presentation of objects using an autocomplete feature to display available objects or sub-objects of a current selected object. At each creation of the URI, the next available objects may be presented as optional to continue navigation. For example, once an object is selected, sub-objects may be displayed, and selected. Selecting a sub-object may display sub-sub-objects. Objects and sub-objects may be based on a directory structure, or may be based on an indication that an object is linked to another object (e.g., sub-object). In other embodiments, navigation of objects may be based on a convention (defined by the objects metadata) and this may be returned as the metadata for knowing a path to explore and available objects to explore. Therefore, navigating a sub-object associated with a selected object may be based on a convention that is defined by the selected object's metadata. In some embodiments, the convention may be described as a regular expression such as the expression illustrated in FIG. 5.

Applications using the formal ODATA standard allow easily identification of a path since ODATA is part of the URI path. In some embodiments, an interface to describe and use an application may be based on a convention other than OData. Each application that implements an interface may also receive the result of the last complete URI. A result of each call to the interface may comprise a collection of the autocomplete suggestions that will be available for the user. In some embodiments, this may be achieved using regular expressions.

In some embodiments, the result might be long and pagination mechanism may be used to support such cases. This may also be achieved using filters and selecting on the results to return a limited number of results.

Presentation of available objects to be navigated may be presented in a browser navigation bar, popups, flash UI, forms and any other way that may allow a user to see the available navigation options and to invoke them.

In some embodiments, the method 100 relates to navigation according to a user's role and/or identification. The autocomplete feature associated with the suggested navigation may comprise navigation according to a specific user and/or the user's role. The identity of the user and its associated role may be determined by, but not limited to, an existing session, cookies, or any other mechanism that identify a session and/or a specific user and its associated role. Information and metadata about the user and/or its role may be used by the autocomplete feature available navigation can be limited or expanded based on the user and/or its role. Only specific navigation availability may be exposed to certain users based on their role and/or identification. This may allow enforcement (e.g., authorization to view specific files) of the navigation preferences for a user or configuration based on a role. Furthermore, in addition to filtering that may be performed in a backend, a user may personalize the navigation availability in a way that the user defines, according to the metadata, what he/she may want to filter out from the autocomplete result. In other words, a suggestion of files that are associated with an autocomplete function may be based on a user's definition of objects to display.

The method 100 may also be associated with security. Using the aforementioned mechanism associated with user or role based navigation limits access based on security to lower the chances of a leak of backend information. The user/role based interface may be created via an abstract layer which exposes the backend information and objects under specific context and specific availability (according to an organization's decisions). The user and role based navigation may increase security to navigation and the backend information. In some embodiments, objects may be exposed based on internal or external requests and a differentiation between internal and external requests may be made based on a location of the origin of the requests (e.g., internal requests may originate from a first side of a firewall while external requests originate from a second side of the firewall).

Once a developer determines a desired file, the developer may select the file which may transmit a request to open the suggested file. Therefore, the request to open the suggested file may be received at a system.

Now referring to FIG. 3, an embodiment of an apparatus 300 is illustrated. The apparatus 300 may comprise a user interface 301, a main memory 302, a processor 303, a medium 304, and a storage device 305. According to some embodiments, the apparatus 300 may further comprise a digital display port, such as a port adapted to be coupled to a digital computer monitor, television, portable display screen, or the like.

The user interface 301 may allow users to interact with the apparatus 300 using text commands or with images/ graphical icons. In some embodiments, the user interface may comprise a keyboard, mouse, or associated port related thereto. Furthermore, the user interface 301 may comprise a display or a touch screen.

The main memory 302 may comprise any type of memory for storing data, such as, but not limited to, a Secure Digital (SD) card, a micro SD card, a Single Data Rate Random Access Memory (SDR-RAM), a Double Data Rate Random Access Memory (DDR-RAM), or a Programmable Read Only Memory (PROM). The main memory 302 may comprise a plurality of memory modules.

The processor 303 may include or otherwise be associated with dedicated registers, stacks, queues, etc. that are used to execute program code and/or one or more of these elements may be shared there between. In some embodiments, the processor 303 may comprise an integrated circuit. In some embodiments, the processor 303 may comprise circuitry to perform a method such as, but not limited to, the method described with respect to FIG. 1.

The processor 303 communicates with the storage device 305. The storage device 305 may comprise any appropriate information storage device, including combinations of magnetic storage devices (e.g., a hard disk drive), optical storage devices, and/or semiconductor memory devices. The storage device 305 stores a program for controlling the processor 303. The processor 303 performs instructions of the program, and thereby operates in accordance with any of the embodiments described herein. For example, the processor 303 may suggest objects associated with a URI.

The medium 304 may comprise any computer-readable medium that may store processor-executable instructions to be executed by the processor 303. For example, the medium 304 may comprise a non-transitory tangible medium such as, but is not limited to, a compact disk, a digital video disk, flash memory, optical storage, random access memory, read only memory, or magnetic media.

The program may be stored in a compressed, uncompiled and/or encrypted format. The program may furthermore include other program elements, such as an operating system, a database management system, and/or device drivers used by the processor 303 to interface with peripheral devices.

As used herein, information may be “received” by or “transmitted” to, for example: (i) the apparatus 300 from another device; or (ii) a software application or module within the apparatus 300 from another software application, module, or any other source.

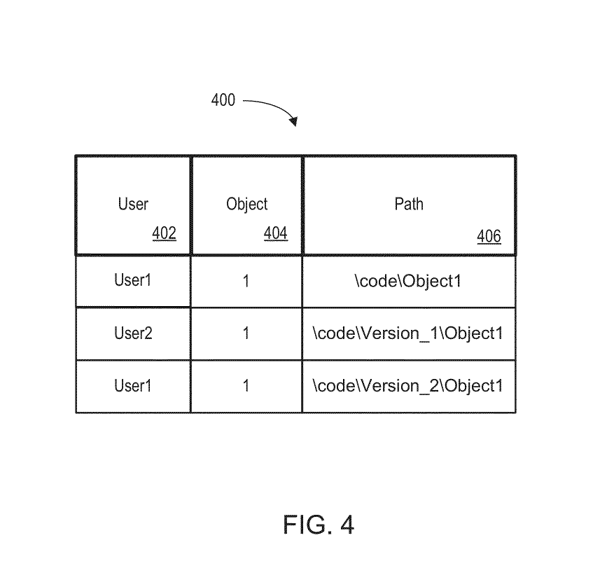

In some embodiments, the storage device 305 stores a database (e.g., including information associated with an application and its associated rules.). An example of a database that may be used in connection with the apparatus 300 will now be described in detail with respect to FIG. 4. Note that the database described herein is only an example, and additional and/or different information may be stored therein. Moreover, various databases might be split or combined in accordance with any of the embodiments described herein.

Referring to FIG. 4, a table is shown that represents a database 400 that may be stored locally at the apparatus 300 according to some embodiments. The table may include, for example, entries relating to specific validations rules that apply to specific applications. The table may also define fields 402, 404, 406 for each of the entries. The fields 402, 404, 406 may, according to some embodiments, specify: a user 402, an object 404, and a path 406.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Moreover, while embodiments have been illustrated using particular types of tables and databases, embodiments may be implemented in any other of a number of different ways. For example, some embodiments might be associated with publically available information, such as flight or train schedules available via web sites.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method comprising:
receiving a URI associated with a RESTful application at an input field; and
suggesting, via a processor, a plurality of REST or OData objects associated with the received URI.

2. The method of claim 1, further comprising:
receiving a request to open one of the plurality of REST or OData objects.

3. The method of claim 2, further comprising:
opening the one of the plurality of REST or OData objects

4. The method of claim 1, wherein the suggestion is based on a role of a user providing the URI associated with the RESTful application at the input field.

5. The method of claim 1, wherein the suggestion may be associated with an autocomplete function and the results of the autocomplete function may be based on a user definition of objects to display.

6. The method of claim 1, wherein the suggested plurality of REST or OData objects is associated with previously opened files.

7. The method of claim 1, further comprising:
navigating a sub-object associated with the one of the plurality of REST or OData objects associated with the received URI based on a convention that is defined by its metadata associated with the one of the plurality of REST or OData objects.

8. The method of claim 1, further comprising:
saving the suggested plurality of REST or OData objects associated with the received URI.

9. A non-transitory computer-readable medium comprising instructions that when executed by a processor perform a method, the method comprising:
receiving a URI at an input field; and
suggesting, via a processor, a plurality of REST or OData objects associated with the received URI.

10. The medium of claim 9, the method further comprising:
receiving a request to open one of the plurality of REST or OData objects.

11. The medium of claim 10, further comprising:
opening the one of the plurliaty of REST or OData objects.

12. The medium of claim 10, wherein the suggestion is based on a role of a user providing the URI associated with the RESTful application at the input field

13. The medium of claim 10, wherein the suggestion may be associated with an autocomplete function and the results of the autocomplete function may be based on a user definition of objects to display.

14. The medium of claim 9, wherein the suggested plurality of REST or OData objects is associated with previously opened files.

15. An apparatus comprising:
a processor;
a non-transitory computer-readable medium comprising instructions that when executed by the processor perform a method, the method comprising:
receiving a URI at an input field; and
suggesting, via a processor, a plurality of REST or OData objects associated with the received URI.

16. The apparatus of claim 15, the method further comprising:
receiving a request to open one of the plurality of REST or OData objects.

17. The apparatus of claim 16, further comprising:
opening the one of the plurliaty of REST or OData objects.

18. The apparatus of claim 16, wherein the suggestion is based on a role of a user providing the URI associated with the RESTful application at the input field

19. The apparatus of claim 16, wherein the suggestion may be associated with an autocomplete function and the results of the autocomplete function may be based on a user definition of objects to display.

20. The apparatus of claim 16, wherein the suggested plurality of REST or OData objects is associated with previously opened files.
